(19) United States
(12) Patent Application Publication
(10) Pub. No.: US 2018/0279647 A1
(43) Pub. Date: Oct. 4, 2018

(54) COMPOSITION FOR ANIMAL FEED ENHANCEMENT

(71) Applicant: Daniel Burch, Kerrville, TX (US)

(72) Inventor: Daniel Burch, Kerrville, TX (US)

(21) Appl. No.: 15/945,739

(22) Filed: Apr. 4, 2018

Related U.S. Application Data
(60) Provisional application No. 62/481,401, filed on Apr. 4, 2017.

(51) Int. Cl. A23K 10/18

(52) U.S. Cl. CPC A23K 10/18; A23Y 2220/03; A23Y 2220/17; A23Y 2280/55; A23Y 2220/67; A23Y 2300/25; A23Y 2280/15; A23Y 2220/49

(57) ABSTRACT

An animal feed supplement that includes dry Enterococcus faecium Fermentation Product, dry Bacillus subtilis Fermentation Product, dry Bacillus licheniformis Fermentation Product, dry Lactobacillus casei Fermentation Product, dry Lactobacillus plantarum Fermentation Product, dry Lactobacillus acidophilus Fermentation Product, dry Bifidobacterium bifidum Fermentation Product, dry Pediococcus acidilactici Fermentation Product, dry Pediococcus pentosaceus Fermentation Product; and dry Lactobacillus lactis Fermentation Product.

### CLAIM OF PRIORITY

This Provisional patent Application claims priority from co-pending U.S. Provisional Patent Application No. 62/481,401 filed on Apr. 4, 2017 entitled COMPOSITIONS FOR ANIMAL FEED ENHANCEMENT, to common inventor Daniel Burch.

### FIELD OF THE INVENTION

The invention relates to animal feed, and particularly in animal feed having combinations of nutrients that provide synergistic benefits. More particularly still, the invention is related to animal feed supplements.

### PROBLEM STATEMENT AND HISTORY

### Interpretation Considerations

This section describes technical field in detail and discusses problems encountered in the technical field. Therefore, statements in the section are not to be construed as prior art.

### Discussion of the History of a Problem Solved

Just like humans, animals—both domesticated and in the wild—are experiencing the effects of mass consumption of processed foods. Whereas in humans, ease of consumption and generally poor nutritional quality as led to obesity, in domesticated and wild animals, the consumption of processed foods has led to other issues related to malnutrition, including low birth weights, lower animal populations, and lower disease resistance. Additionally, these animals often have high levels of growth hormones and other chemicals that have been fed to the animals to compensate for the otherwise poor nutrition. In fact, the widespread use of processed foods has given rise to the concept of (and criticism of) “intensive animal farming.”

Accordingly, what is needed is a natural composition of feed additives that increase the digestibility and absorption of feed nutrients such that the animals can thrive on reduced amounts of antibiotics, do not need hormones, and avoids introduction of these additives into the human food supply. The present invention provides such a composition.

### SUMMARY OF THE INVENTION

The invention relates to compositions for animal feed, for animals such as varmints (such as deer and rabbits), which is also useful for feeding cattle, horses and other domesticated animals (including exotic animals). In particular, the animal feed composition is based primarily on prebiotics and live naturally occurring micro organisms.

The composition may be added to any animal feed, including feed for fodder and/or forage. Fodder, including compound feed, refers herein to foods or forages given to the animals (including plants cut and carried to them), rather than that which they forage for themselves. It includes hay, straw, silage, compressed and pelleted feeds, oils and mixed rations, and sprouted grains and legumes. Feed grains are the most common source of animal feed in the United States. In practice, the inventive composition is added to feed at the point of animal consumption.

### DETAILED DESCRIPTION OF THE PREFERRED EMBODIMENT

### Interpretation Considerations

While reading this section (An Exemplary Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

The composition is designed as a dietary supplement to normal animal feed—including feed for fodder and/or forage—for both wild animals and domesticated animals. For example, the composition may be used to enhance animal feed for deer, exotic hoof stock, sheep, goats, pigs, cattle and horses, for example. Fodder, includes hay, straw, silage, compressed and pelleted feeds, oils and mixed rations, and sprouted grains and legumes, for example. In practice, the inventive composition is typically added to feed at or near the point of animal consumption. However, the composition could be added to feed during processing and prior to transport, sale, or field distribution.

The animal feed composition is based primarily on prebiotics and live naturally occurring microorganisms (also spelled as “micro organisms”). The compound generally improves digestion and nutrient absorption, and the increased nutrient absorption based on the synergistic benefits of the compound gives animals a greater weight without hormones, improves the animal's disease resistance, and gives the animal a thicker and healthier coat. Furthermore, the inventive compound does not interfere with the flavor of the feed to the animals, and so is consumed without objection.

Accordingly, in one preferred embodiment the compound is a unique blend of ten (10) stains of bacteria, along with prebiotic and several yeasts and several molds. The combination gives rise to a multi species probiotic and digestion supplement that is readily consumable by cattle, horses, sheep, goats, pigs, deer and exotics. In particular, it is consumable by mono-gastric and rumen animals.

In one instance, animals receiving the inventive composition have had live gastro-intestinal tract samples taken, in which new GI flora/fauna (“bugs”) were identified. The presence of these bugs was attributed to the use of the inventive compounds described herein. The inventive composition was heat stable up to 200 degrees in lab test on the bacteria alone.

The inventive compound discussed below is in one embodiment typically in the form of a fine powder, being a ‘natural’ off-white color, and having a bland aroma. In an alternative embodiment (sometimes referred to as a “faun paste,” the inventive compound is physically an op natural-tan color paste, with a smooth, slightly glossy appearance, and having a bland aroma.

### Ingredients

The ingredients of the inventive composition preferably are chosen from, in a powder embodiment:

Glucose, Maltodextrins, Fructoogliosaccharide, Citric Acid, Silicon Dioxide, Dried Enterococcus faecium Fermentation Product, Dried Bacillus subtilis Fermentation Product, Dried Bacillus licheniformis Fermentation Product, Dried Lactobacillus casei Fermentation Product, Dried Lactobacillus plantarum Fermentation Product, Dried Lactobacillus acidophilus Fermentation Product, Dried Bifidobacterium bifidum Fermentation Product, Dried Pediococcus pentosaceus Fermentation Product, Dried Pediococcus acidilactici Fermentation Product, and Dried Lactobacillus lactis Fermentation Product.

Glucose provides energy for the animal.

Maltodextrins provide thickness to the feed and makes it more appealing for the animal to eat.

Fructoogliosaccharide, a plant extract, provides a sweet flavor for the animal and stimulates positive bacteria growth.

Citric Acid provides flavoring and preservative benefits.

Silicon Dioxide preserves the texture of the food.

Dried Enterococcus faecium Fermentation Product is a digestive bacteria which, although reported to be pathogenic, is discovered in the present formulation to provide positive pro-biotic benefits.

Dried Bacillus subtilis Fermentation Product provides digestive tract benefits as an active immune support.

Dried Bacillus licheniformis Fermentation Product assist with enzyme production.

Dried Lactobacillus casei Fermentation Product provides pro-biotic benefits especially in the digestion of dairy products.

Dried Bifidobacterium bifidum Fermentation Product provides pro-biotic benefits.

Dried Lactobacillus plantarum Fermentation Product helps develop pro-biotics.

Dried Lactobacillus acidophilus Fermentation Product is a common gastro-intestional pro-biotic.

Dried Pediococcus pentosaceus (or, by some sources, lactobacillus) Fermentation Product assist with the digestion of leafy-green vegetables.

Dried Pediococcus acidilactici Fermentation Product provides pro-biotic benefits across a spectrum of temperatures.

Dried Lactobacillus lactis Fermentation Product supports digestion in the lower gastro-intestinal tract.

The additional ingredients of the inventive composition preferably are chosen from, in a paste embodiment:

### Soybean Oil, Colostrum, Sucrose, Corn Starch, Lecithin, Glycerin, and Kaolin Clay.

Soybean Oil provides moisture and a good source of fat calories.

Colostrum contains antibodies that naturally help prevent many diseases.

Sucrose provides a good source of carbohydrate energy.

Corn Starch provides adhesion for the food, especially when provided in pellet form.

Lecithin provides smoothness to the food, making it more palatable for the animal.

Glycerin provides moisture and is a humectant.

Kaolin Clay provides a nice texture to the food, and also provides surprising natural medical benefits to the animal as a natural coagulant.

Accordingly in one embodiment the invention comprises an animal feed supplement that includes dry Enterococcus faecium Fermentation Product, dry Bacillus subtilis Fermentation Product, dry Bacillus licheniformis Fermentation Product, dry Lactobacillus casei Fermentation Product, dry Lactobacillus plantarum Fermentation Product, dry Lactobacillus acidophilus Fermentation Product, dry Bifidobacterium bifidum Fermentation Product, dry Pediococcus acidilactici Fermentation Product, dry Pediococcus pentosaceus Fermentation Product; and dry Lactobacillus lactis Fermentation Product.

One exemplary composition according to the invention includes the ingredient in the proportions of: (1) Bacteria (approximate total of 7 B/gm) comprising Enterococcus faecium —12.5% or 875 million CFU/gm, Pediococcus acidilactici —12.5% or 875 million CFU/gm, Pediococcus pentosaceus —12.5% or 875 million CFU/gm, Lactococcus lactis —12.5% or 875 million CFU/gm, Lactobacillus acidophilus—12.5% or 875 million CFU/gm, Lactobacillus casei —12.5% or 875 million CFU/gm, Lactobacillus plantarum —12.5% or 875 million CFU/gm, and Bifidobacterium bifidum —12.5% or 875 million CFU/gm, and (2) Spores (approximate total of 40M/gm) comprising Bacillus subtilis —80% or 32 million CFU/gm, and Bacillus licheniformis —20% or 8 million CFU/gm.

Dry Cell Base

| | (of q.s.) | Range Low | Range High |
|---|---|---|---|
| Glucose | 50-70% | 31.4 | 43.96 |
| Maltodextrins | 20-50% | 12.56 | 31.4 |
| Citric Acid | 5-10% | 3.14 | 6.28 |
| Fructoogliosaccharides | 2-5% | 1.256 | 3.14 |
| Silicon Dioxide | 1-2% | 0.628 | 1.256 |

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An animal feed supplement, comprising:
dry Enterococcus faecium Fermentation Product;
dry Bacillus subtilis Fermentation Product;
dry Bacillus licheniformis Fermentation Product;
dry Lactobacillus casei Fermentation Product;
dry Lactobacillus plantarum Fermentation Product;
dry Lactobacillus acidophilus Fermentation Product;
dry Bifidobacterium bifidum Fermentation Product;
dry Pediococcus acidilactici Fermentation Product;
dry Pediococcus pentosaceus Fermentation Product; and
dry Lactobacillus lactis Fermentation Product.

2. An animal feed supplement, comprising:
bacteria (approximate total of 7 B/gm) comprising
Enterococcus faecium at 12.5% or 875 million CFU/gm,
Pediococcus acidilactici at 12.5% or 875 million CFU/gm,
Pediococcus pentosaceus at 12.5% or 875 million CFU/gm,
Lactococcus lactis at 12.5% or 875 million CFU/gm,
Lactobacillus acidophilus at 12.5% or 875 million CFU/gm,
Lactobacillus casei at 12.5% or 875 million CFU/gm,
Lactobacillus plantarum at 12.5% or 875 million CFU/gm,
and Bifidobacterium bifidum at 12.5% or 875 million CFU/gm, and spores (40M/gm) comprising Bacillus subtilis at 80% or 32 million CFU/gm,
and Bacillus licheniformis at 20% or 8 million CFU/gm.
